(19) United States
(12) Patent Application Publication
(10) Pub. No.: US 2005/0126430 A1
(43) Pub. Date: Jun. 16, 2005

(54) Building materials with bioresistant properties

(76) Inventors: James Edward Lightner JR., Temecula, CA (US); Caidian Luo, Alta Loma, CA (US); Donald James Merkley, Alta Loma, CA (US); Trina Ann Ormonde, Bloomington, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/014,635

(22) Filed: Dec. 16, 2004

Related U.S. Application Data
(63) Continuation-in-part of application No. 10/919,587, filed on Aug. 17, 2004.
Application No. 10/919,587 is a continuation of application No. 09/969,964, filed on Oct. 2, 2001, now Pat. No. 6,777,103.
(60) Provisional application No. 60/241,212, filed on Oct. 17, 2000.

(51) Int. Cl. B28B 1/14; C23C 28/00; C23C 18/00

(52) U.S. Cl. 106/15.05; 264/330; 264/333; 427/421.1; 427/430.1; 427/420; 106/18.32

(57) ABSTRACT

A building article incorporating a biocidal agent, such as copper oxine, that inhibits the growth of mold, fungi, algae, mildew, bacteria, lichen, and other undesirable biological growth is provided. The biocidal agent can be a biocide, fungicide, germicide, insecticide, mildewcide, or the like. The biocidal agent can be interspersed throughout the matrix of the article; applied as a surface treatment to the article; or applied as a treatment to the fibers reinforcing the article. The building article can include tile backer boards, decks, soffits, trims, decking, fencing, roofing, cladding, sheathing, and other products. The building article can also include a variety of different composite materials such as cement, gypsum, wood, and wood/polymer composites.

### RELATED APPLICATIONS

This application is a continuation-in-part of U.S. patent application Ser. No. 10/919,587 filed Aug. 17, 2004, which is a continuation of U.S. Pat. No. 6,777,103 filed Oct. 2, 2001, which claims the benefit of U.S. Provisional Patent Application No. 60/241,212 filed Oct. 17, 2000, the entirety of each of which is hereby incorporated by reference.

### BACKGROUND OF THE INVENTION

1. Field of the Invention

This invention relates to composite building materials, and more particularly to a composite building material that is resistant to undesirable biological growth such as mold, mildew, algae and the like, including material treatment methods, formulations, methods of manufacture and products with improved material properties relating to the same.

2. Description of the Related Art

Mold and mildew growth can occur in walls of residential or industrial buildings with poor ventilation or excessive moisture either inside or outside of the structure. For example, bathrooms, laundry rooms, basements can be susceptible to mold growth if temperature and humidity conditions are maintained in a range that supports mold growth. In addition to moisture, mold or mildew also needs a food source. Some building products contain materials that can support the growth of mold or mildew such as the paper covering on gypsum panels or organic fibers in the tile backer boards. As such, there is a need to inhibit mold growth in both residential and industrial buildings as it can be appreciated that the presence of mold, mildew, and fungus in any part of a building structure is generally not desirable.

While biocides have been added to various coating materials such as paints and sealants to resist mold and mildew growth, most of the conventional biocides do not survive well in alkaline environment, such as that found in fiber cement and concrete building materials. Moreover, biocides incorporated into a coating such as paints and sealants often do not effectively protect the underlying building article as it is difficult for the biocide to diffuse through the coating and contact the underlying surface. Additionally, the conventional biocides are typically not suitable for direct application to certain building materials as the biocides may react directly with materials commonly used in building articles, such as cement, gypsum and wood, thereby weakening them over the long term.

### SUMMARY OF THE INVENTION

In view of the foregoing, there is a need for a mold resistant building article, such as tile backer boards, decking, fencing, roofing, cladding, soffit, trim, or sheathing. To this end, there is a particular need for an effective biocide treatment for protecting composite materials such as cement, fiber cement, gypsum, gypsum fiber composite, wood, hardboard, medium density fiberboard, oriented strandboard, and wood/polymer composites against mold, mildew and other undesirable biological growth. There is also a need for a biocide that is heat and/or alkali stable and can be directly applied to the building article surface or incorporated into the matrix of the building article without adversely affecting the strength or performance of the article.

As used herein, the term “biocide” shall refer to any substance that destroys or inhibits the growth of fungi, mold, algae, lichens, mildew, or bacteria, which includes but is not limited to biocides, antimicrobials, antibacterial agents, antifungal agents, fungicides, bactericides, germicides, insecticides, mildewcides, and the like. The term “mold” shall refer to any organism that can degrade, destroy or live off of organic matter, which includes but is not limited to mold, mildew, fungus, bacteria, lichen, and the like. The term “mold resistant building article” shall refer to a building article that utilizes a biocide to inhibit mold growth on or in the article.

In one aspect, the preferred embodiments of the present invention provide a building article incorporating copper oxine (also known as copper oxene, Bis (8-oxyquinoline) copper, copper 8-hydroxyquinoline or copper 8-hydroxyquinolate) as a biocide to inhibit mold growth. The building article is preferably comprised of a material selected from the group consisting of cement, fiber cement, gypsum, gypsum fiber composite, wood, hardboard, medium density fiberboard, oriented strandboard, and wood/polymer composites. In certain preferred embodiments, the building article comprises about 0.025%-2% copper oxine by weight of the material forming the article. In one embodiment, the copper oxine is mixed into and interspersed throughout at least a portion of the material forming the article. The copper oxine can be interspersed throughout the material by being incorporated into an admixture or slurry forming the material or incorporated as a treatment agent in the fibers, fillers, or other components of the material. In another embodiment, the copper oxine is adhered to a first surface of the article and preferably directly contacts the surface. The copper oxine can also extend from the first surface into the subsurface layers of the building article. In some implementations, a coating is formed on the first surface of the article to cover the copper oxine thereon. The coating is preferably selected from the group consisting of primers, sealants, and paints. The articles incorporating biocide can be a variety of different building products such as those selected from the group consisting of tile backer boards, decks, soffits, trims, decking, fencing, roofing, cladding, and sheathing. Additionally, the building article can comprise a board, a plank, a flat sheet, a panel, or a stake. In one embodiment, the article comprises a gypsum based core having two opposing surfaces and paper sheets bonded to the opposing surfaces. The copper oxine can be adhered to at least one surface of the paper sheets, applied to fibers reinforcing the paper sheets, or incorporated in the gypsum based core.

In another aspect, the preferred embodiments of the present invention provide a method of forming a building article that is resistant to mold growth. The method includes forming a building article having a first surface and applying a biocide comprising copper oxine to the first surface. The building article is preferably comprised of a material selected from the group consisting of cement, fiber cement, gypsum, gypsum fiber composite, wood, hardboard, medium density fiberboard, oriented strandboard, and wood/polymer composites. In one embodiment, the copper oxine is applied directly to the first surface of the building article. In another embodiment, the copper oxine is applied to the first surface via a solution comprising about 0.1-2% copper oxine, about 1-10% additives, and about 50-99% water by weight. All percentages specified herein are weight percentages unless otherwise noted. In some implementations, the additives are selected from the group consisting of sealants, paints, and primers.

In yet another aspect, the preferred embodiments of the present invention provide a method of forming a building material that is resistant to mold growth. The method includes combining copper oxine with ingredients for forming a composite material selected from the group consisting of cement, fiber cement, gypsum, gypsum fiber composite, wood, hardboard, medium density fiberboard, oriented strandboard, and wood/polymer composites. The method further includes forming a mixture comprising copper oxine and the ingredients wherein the biocide is dispersed throughout at least a portion of the mixture and processing the mixture to form a building material which incorporates copper oxine therein. In one embodiment, the ingredients comprise a hydraulic binder, aggregates, and fibers. In another embodiment, processing the mixtures comprises processing the copper oxine and ingredients into a green shaped article, followed by autoclave curing of the green shaped article.

In yet another aspect, the preferred embodiments of the present invention provide a method of forming a fiber reinforced building material that is resistant to mold growth. The method comprises combining copper oxine treated fibers with ingredients for forming a composite material selected from the group consisting of cement, fiber cement, gypsum, gypsum fiber composite, wood, hardboard, medium density fiberboard, oriented strandboard, and wood/polymer composites. The method further includes forming a mixture comprising the copper oxine treated fibers and the ingredients; processing the mixture to form a building material that is reinforced with copper oxine treated fibers.

In yet another aspect, the preferred embodiments of the present invention provide a building article comprising fiber cement and a biocide, wherein the biocide directly contacts the fiber cement and substantially inhibits mold growth therein. In one embodiment, the biocide is interspersed throughout at least a portion of the fiber cement. In another embodiment, the biocide is applied to a first surface of the article such that the biocide directly contacts the fiber cement on the first surface. In some implementations, the biocide penetrates the first surface of the article and extends into subsurface layers of the article, preferably for a depth of at least 10 microns. In one preferred embodiment, the biocide is selected from the group consisting of copper oxine, zinc stearate, calcium borate, zinc borate, barium borate, zinc omadine, zinc omadine/zinc oxide mix, sub 10 micron copper powder, and mixtures thereof. The biocide is preferably substantially stable in an alkali and/or high temperature environment. The building article can include a variety of different building products such as those selected from the group consisting of primed fiber cement articles, pre-finished fiber cement articles, tile backer boards, decks, soffits, trims, decking, fencing, roofing cladding, and sheathing.

In yet another aspect, the preferred embodiments of the present invention provide a building material formulation comprising a formulation for forming a composite material selected from the group consisting of cement, fiber cement, gypsum, gypsum fiber composite, wood, hardboard, medium density fiberboard, oriented strandboard, and wood/polymer composites and an admixture comprising a biocide. Preferably, the admixture comprises about 0.025%-2% by weight of the formulation. In one embodiment, the admixture includes a biocide selected from the group consisting of copper oxine, zinc stearate, calcium borate, zinc borate, barium borate, zinc omadine, zinc omadine/zinc oxide mix, sub 10 micron copper power, and mixtures thereof. The biocide can be in the form of a biocide powder or a timed-release biocide. In certain embodiments, the admixture comprises a biocide solution mixed with a predetermined amount of a porous glass, ceramic, mineral or polymeric material so as to permit timed release of the biocide.

In yet another aspect, the preferred embodiments of the present invention provide a method of forming a building article that is resistant to mold growth. The method comprises forming a fiber cement article having a first surface and applying a biocide to the first surface wherein said biocide directly contacts the fiber cement. In one embodiment, the biocide applied to the first surface comprises a copper oxine solution. In another embodiment, applying the biocide comprises spraying a solution containing the biocide directly to the first surface. In one embodiment, applying the biocide comprises applying a biocide having a viscosity of between about 1 and 1,000 centipoises. The biocide can also be applied to the first surface by a method selected from the group consisting of spray coating, dip coating, curtain coating, roller or brush coating, flooding, and vacuum coating. In certain embodiments, the method further comprises applying a sealant to the fiber cement article after applying the biocide to the first surface of the article.

### BRIEF DESCRIPTION OF THE DRAWINGS

FIG. 1A illustrates a method of manufacturing a mold resistant building article with a biocide surface treatment;

FIG. 1B illustrates a method of manufacturing a mold resistant building article by incorporating biocide treated fibers to the article;

FIG. 1C illustrates a method of manufacturing a mold resistant building article with a biocide admixture incorporated into the matrix of the building article;

FIG. 2 illustrates a building article incorporating a surface treatment that is substantially resistant to mold growth; and

FIG. 3 illustrates a building article incorporating one or more biocides in the matrix of the material forming the article.

### DETAILED DESCRIPTION OF THE PREFERRED EMBODIMENTS

Certain preferred embodiments of the present invention provide a building article that incorporates a biocide which renders the building article substantially resistant to mold growth, including formulations and methods for making such an article. The mold resistant building article can include both interior and exterior building products such as tile backer boards, cladding, trim, roofing, fencing, fascia, soffits, sheathing, and the like.

The biocide properties are preferably imparted to the building article by one or more general methods. The methods include (1) applying a surface treatment containing a biocide to the article; (2) incorporating a biocide into an admixture which is directly batched into the mixture to form the article; and (3) treating a component of the article, such as reinforcement fibers, with a biocide. Each of these methods will be described in greater detail below.

Surface Treatment

The biocide can be imparted to the building article by a biocide surface treatment. In one embodiment, a solution or mixture containing one or more biocides can be applied to a surface of the building article by a variety of different methods including but not limited to spray coating, dip coating, curtain coating, roller or brush coating, flooding, and vacuum coating. In one embodiment, the biocide surface treatment can be applied to a treated or an untreated building article, such as a fiber cement board. The biocide can be applied to a surface of the building article in a manner such that the biocide directly contacts the building article or that the biocide is embedded in and carried by a layer of coating such as sealant or paint that is applied to a surface of the article. For example, the biocide surface treatment can be applied to primed fiber cement boards in which the biocide is incorporated into the primer. Alternatively, the biocide surface treatment can also be applied to a pre-finished fiber cement board by incorporating a biocide into the paint. In certain embodiments, a biocide surface treatment can be applied to the surface of the article followed immediately by the application of a film forming sealer.

In one embodiment, the biocide surface treatment entails applying a solution or mixture comprising about 0.1%-2% copper oxine, more preferably about 0.2%-1%, more preferably about 0.5%; and about 1%-10% of a latex sealer, more preferably about 4%-8%, more preferably about 6%; and about 50%-99% water, more preferably about 75%-95%, more preferably about 93.5% by weight. In addition to latex sealers, other sealers based on organic polymers or copolymers (including, but not limited to organosilanes, acrylics, acrylic copolymers, polyvinyl alcohol), polyethylene glycol, and the like using organic or water solvents as carriers can also be used. The biocide surface treatment solution or mixture preferably has a pre-selected viscosity to allow the subsurface penetration or to enable the material to remain on the surface as desired. In one embodiment, the biocide surface treatment solution or mixture has a viscosity between about 1-1,000 centipoise.

In one implementation, the biocide surface treatment solution or mixture is applied using a spray coater in which the biocide application is about 6 to 8 wet grams/square foot on one side, creating a thin film of biocide surface treatment. In some embodiments, the biocide surface treatment is allowed to penetrate below the surface of the article, preferably at least 10 micron below the surface. The biocide surface treatment embodiments containing a latex or other film forming material may be dried by various types of curing methods. The curing methods include thermal curing such as infrared and hot air or radiation curing such as UV (ultra violet) and EB (electron beam) or any other methods that can reach a temperature, preferably about 350° F. (175° C.), that is sufficient to dry, cure, or activate the surface treatment in a short amount of time.

The biocide surface treatment can be applied to a variety of different building materials including but not limited to cement, fiber cement, gypsum, gypsum fiber composite, wood, hardboard, medium density fiberboard, oriented strandboard, and wood/polymer composites. For fiber cement articles, it is preferred that the biocide solution be directly sprayed onto a surface of the article in a manner such that the biocide directly contacts the fiber cement. By directly contacting the fiber cement, the biocide imparts mold resistant properties to the fiber cement itself as opposed to providing such properties only to the coating covering the fiber cement. Additionally, biocide surface treatments that utilize copper oxine as the biocide are also very well suited to a variety of different building material formulations, such as foamed cement panels, concrete block, autoclaved aerated concrete, fiberglass mesh reinforced cement boards, gypsum based panels or wall boards, wood composite panels, OSB, plywood, hardboard, wood filled polymer composites, foamed plastic composites and other composite construction and building materials which may have an alkaline characteristic or those that are processed or cured at elevated temperatures.

Admixture

The biocide can also be directly incorporated into the building material formulation. In one embodiment, a biocide is incorporated into the slurry for forming the building material via an admixture. The biocide admixture can include any of the biocides described herein. In certain preferred embodiments, the biocide selected is copper oxine. Copper oxine is preferred because it is stable in an alkaline environment such as that of a cementitious matrix and also stable under high temperature conditions such as the elevated temperatures at which the building article is cured. The inventors have found that copper oxine also has an affinity for the reactive hydroxyl groups found on the silicates that comprise many building materials. This affinity is often sufficient to substantially reduce leaching of the copper oxine from the building article. The biocide may comprise about 0.001%-0.5% of the dry weight of all the materials in the final composition. One example of a preferred building article formulation incorporating a biocide is as follows.

TABLE 1
A preferred formulation for a biocide fiber cement article

| Raw Material | Weight % | Example |
|---|---|---|
| Binder | 5%-80% | 28.70% |
| Portland cement | | |
| Aggregate | 0%-80% | 50.30% |
| Silica | | |
| Fiber | 4.1%-15% | 7% |
| Cellulose | | |
| Additives | 0%-10% | 4% |
| Metal Hydroxide | | |
| LDA | 0%-90% | 10% |
| Microspheres | | |
| Biocide | 0.1%-1% | 0.50% |
| Copperoxene | | |

The biocide can be added to the admixture as a dry powder or an aqueous dispersion. If batched in an aqueous dispersion, constant stirring of the biocide is preferred to make sure the biocide is mixed in the aqueous dispersion. The preferred biocide, copper oxine, can be mixed with other fiber cement raw materials in the proportions described above in Table 1 and produce substantially no adverse effects in mechanical properties such as bending strength, MOR, z-direction tensile strength and toughness.

In one embodiment, the building material incorporating a biocide admixture is a fiber reinforced composite material, preferably a fiber cement composite such that those disclosed in U.S. Pat. Nos. 6,572,697 and 6,346,146, Australian Patent No AU 515151, each of which is incorporated by reference herein in its entirety. The inventors have found that the copper oxine admixture as described above is also a suitable biocide admixture in a variety of other building material formulations, such as foamed cement panels, concrete block, autoclaved aerated concrete, fiberglass mesh reinforced cement boards, gypsum based panels, wood composite panels, OSB, plywood, hardboard, wood filled polymer composites, foamed plastic composites and particularly those building materials which may have an alkaline environment or those that are processed or cured at elevated temperature.

In certain embodiments, a reservoir of active biocide is maintained within the building article. A staged or timed-release biocide admixture may be prepared by blending a predetermined amount of a liquid biocide solution with a predetermined amount of a porous glass, ceramic or mineral material, preferably in a powdered or particulate form. By mixing a predetermined amount of biocide treated material into the building material formulation, a localized region of relatively high biocide concentration may be maintained within the building article. The biocide will then diffuse or migrate over time into the remainder of the building article; replacing biocide that has been depleted or rendered ineffective. Porous glass, ceramic or mineral materials suitable for this purpose include but are not limited to diatomaceous earth, zeolite, expanded volcanic ash, ground glass frit, molecular sieves (spherical porous ceramics), and the like. This form of biocide admixture is suited to wood or highly porous materials.

Fiber Treatment

The biocide can also be incorporated in the building article by treating a component of the article such as the fibers with a biocide. For example, the fibers can be treated with a biocide using methods described in U.S. Pat. No. 6,777,103. In one embodiment, copper oxine is a preferred biocide for treating fibers as it has an affinity to the organic fibers in an aqueous media. In particular, copper oxine is a preferred biocide for cellulose fibers. Without wishing to be bound by theory, the inventor believes that the hydrophobic nature of the copper oxine and the establishment of weak coordinate covalent bonds with the hydroxyl groups in the cellulose result in the affinity between copper oxine and cellulose fibers.

Chemicals that can be used as effective biocides for the fiber treatment include, but are not limited to, sodium, potassium, calcium, zinc, copper, and barium salts of carbonate, acetate, pulmitate, oleate, stearate, phosphate, silicate, halide, and borate in all forms; zinc carboxylates; boric acids; sodium dichromate; copper chrome arsenate (CCA); chromated copper borate (CBC); ammoniacal copper arsenate (ACA); ammoniacal copper zinc arsenate (ACZA); copper chromium fluoride (CFK); copper chromium fluoroborate (CCFB); copper chromium phosphorous (CCP); and other inorganic compounds.

Furthermore, organic compounds can also be used for the fiber treatment, including but not limited to substituted azoles with a variety of formulations; organochloride such as pentachlorophenol (PCP); quaternary ammonium compounds (AAC); or copper oxine in various formulations; tri-n-butyltin oxide (TBTO) of all kinds of formulations; tri-n-butyltin naphthenate (TBTN) in various formulations; didecyldimethylammonium bromide (DDAB) in various formulations; didecyldimethylammonium chloride (DDAC) of all kinds in various formulations; and other fungicides of all kinds; algaecides of all kinds; and termite preservatives of all kinds.

The fibers are preferably treated with one or more biocides listed above, depending on the particular attributes needed for a specific application of the fiber cement material. The fiber treatment preferably occurs in the presence of water or organic solvents, with the biocide treatment of the fiber, either through depositing, chemical reaction or other mechanism, preferably occurring upon contact of the chemical compounds with the cellulose fibers. It can be appreciated that the above lists of chemicals are merely illustrative examples of substances that can be used for fiber biocide treatment. The chemicals can also be any other suitable inorganic or organic compounds that have inhibitory effects to fungal, bacterial, algae, and mold growth.

The cellulose pulps can be made of a variety of lignocellulosic materials including softwood, hardwood, agricultural raw materials, recycled waste paper or any other forms of lignocellulosic materials. Preferably, the fibers that are selected for biocide treatment are individualized fibers. Preferably, the fiber lengths are in the range of about 0.2 to 7 mm, more preferably, in the range of about 0.6 to 4 mm.

Certain preferred formulations of the composite material of the present invention include a cementitious hydraulic binder, aggregate, biocide treated cellulose fibers, density modifiers, and various additives to improve different material properties. The cementitious binder is preferably Portland cement but can also be, but is not limited to, high alumina cement, lime, ground granulated blast furnace slag cement, and high phosphate cement, or mixtures thereof. The aggregate is preferably ground silica sand but can also be, but is not limited to, amorphous silica, micro silica, diatomaceous earth, coal combustion fly and bottom ashes, rice hull ash, blast furnace slag, granulated slag, steel slag, mineral oxides, mineral hydroxides, clays, magnasite or dolomite, metal oxides and hydroxides, polymeric beads, or mixtures thereof. In certain preferred embodiments, the biocide comprises about 0.005%-5% of the dry weight of the fibers.

It will be appreciated that biocides incorporated via surface treatment, admixture, or fiber treatment can be applied to a variety of composite materials, including but not limited to cement, fiber cement, gypsum, gypsum fiber composite, wood, hardboard, medium density fiberboard, oriented strandboard, and wood/polymer composites.

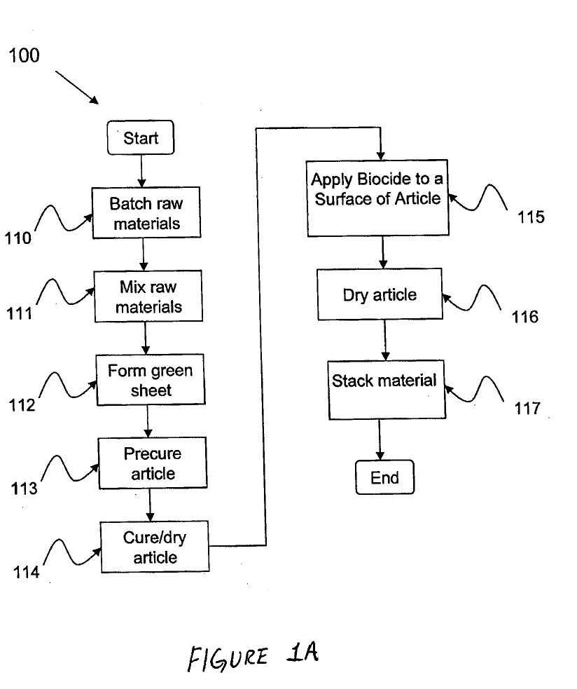

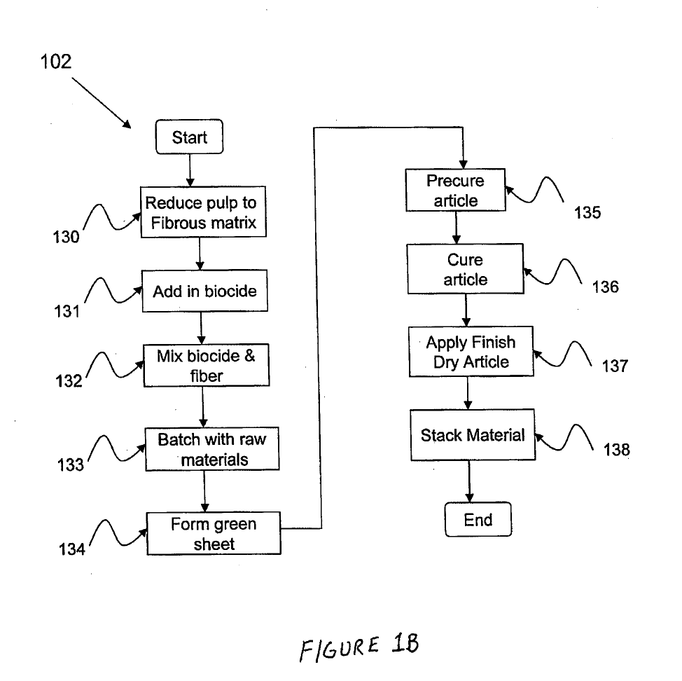

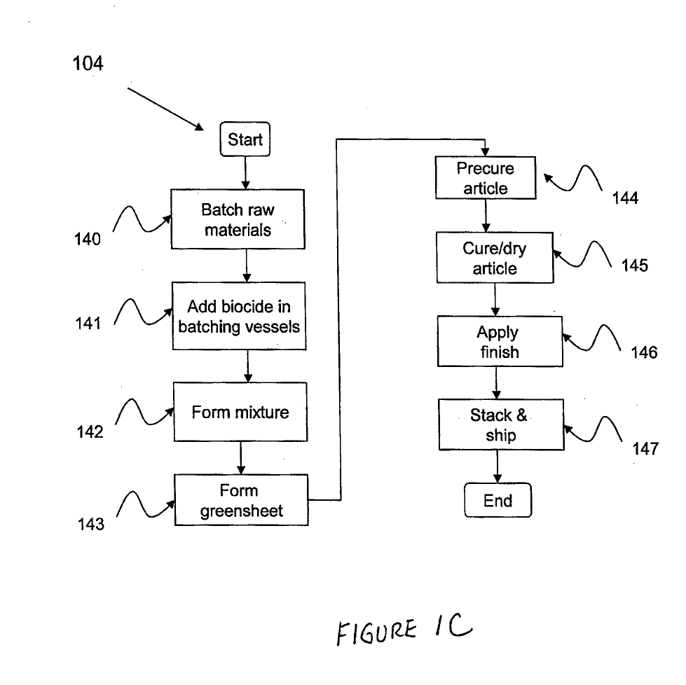

FIG. 1A illustrates a method 100 of manufacturing a mold resistant building article by applying a biocide treatment to a surface of the building article. The method 100 includes the following steps:

Step 110: Batch Raw Materials

In this step, raw materials are batched in accordance with known formulations and operation procedures.

A formulation of a preferred embodiment of this step includes:
about 10%-80% cement (cementitious binder);
about 20%-80% silica (aggregates);
about 0%-50% density modifiers;
about 0-10% additives; and
about 0.5%-20% cellulose fibers, or a combination of biocide treated cellulose fibers, and/or regular cellulose fiber, and/or natural inorganic fibers, and/or synthetic fibers.
   Step 111: Mix Raw Materials

In this step, raw materials are mixed together using known techniques to create a fiber cement mixture.

Step 112: Form green sheet

In this step, the fiber cement mixture is made into a fiber cement article by methods such as the Hatschek process, extrusion, mazza former, magnani, flow-on, casting, injection molding, hand lay-up, filter pressing, fourdrinier forming, multi-wire forming, gap blade forming, gap roll/blade forming, bel-roll forming, and others.

Step 113: Precure the Article

In this step, the fiber cement article is precured for at least 12-24 hours. This typically takes place in an ambient environment.

Step 114: Cure Article

In this step, the fiber cement article is cured in an autoclave at elevated temperatures such as at about 180° C. and pressures for at least 8 hours. Alternatively, the article can be cured for 25 to 30 days at ambient conditions.

Step 115: Apply Biocide Mixture to Article

In this step, the biocide, preferably copper oxine, is applied directly to the fiber cement. In one embodiment, approximately 0.01% to 2% copper oxine is mixed with about 50%-99% water, and 1%-10% additives. The application amount can be about 2-12 wet grams/ft², more preferably about 4-10 wet grams/ft², and most preferably about 6-8 wet grams/square foot on the article. The treatment is only on the surface and forms a thin film over the article. At least one side is coated (the side towards the wet area), but all sides can be coated. The treatment is applied with a spray coater or any means suitable for a coating process, such as curtain coating, brush coating, roller, flooding, dip, or the like. Alternatively, it is also possible to surface treat the article between each of the micro-layers to instill biocide protection, particularly if the article is layered.

Step 116: Dry Article

In this step, the recently sealed board goes through an array of drying ovens or heaters at a temperature near 350° F., or 175° C., on a moving conveyor. Other means of drying the surface treatment include radiation curing, including UV and EB or thermal curing using infrared or hot air.

Step 117: Stack Material for Shipping

In this step, the fiber cement articles are stacked and packaged for storage or shipment.

FIG. 1B illustrates a method 102 of manufacturing a mold resistant building article by treating the reinforcement fibers with a biocide. Further detailed reference related to fiber treatment described in this method can be found in U.S. Pat. No. 6,777,103. The method 102 includes the following steps.

Step 130: Reduce Pulp to Fibrous Matrix

In this step, pulp is refined down to a certain freeness required for a fiber cement article. The pulp and other ingredients are mixed together in a slurry in accordance with a known fiber cement formulation, such as the formulations described herein.

Step 131: Add in Biocide

In this step, the biocide, preferably copper oxine, is added into the fiber slurry in a powder or aqueous form. Approximately 0.005% to 2% of the dry weight of the fiber is added. In one embodiment, the biocide can be in powder form or in an aqueous dispersion solution. Approximately 0-3%, more preferably 0.0001%-1%, more preferably 0.001% to 0.5% of the dry weight of all raw materials comprises biocide.

In one embodiment, the fiber cement formulation comprises about 0.1%-0.5% copper oxine, preferably about 0.1%, preferably about 0.025%, preferably about 0.05%, preferably about 0.075%, preferably about 0.1%, preferably about 0.25%, preferably about 0.5%. In another embodiment, the fiber cement formulation comprises about 0.5% copper oxine and about 0.5% zinc omadine, or about 0.2% copper oxine and about 0.5% zinc omadine.

Step 132: Mix Biocide & Fiber

In this step, the biocide and fiber are mixed anywhere from about 10 minutes to 2 hours at an ambient temperature to treat the fibers with biocide. In one embodiment, the fibers are mixed with copper oxine. Copper oxine has a strong affinity for organic fibers, so the longer the copper oxine and fibers are mixed, the more the treatment stays with the fibers and does not encourage leaching in the future.

Step 133: Batch with Raw Materials

In this step, the treated fiber is batched and mixed with the other raw materials to form a cementitious mixture. Preferably, the amount of fiber is the same (3%-8%) as the existing formulations use.

Step 134: Form Greensheet

In this step, the fiber cement mixture is made into a fiber cement article by means such as the Hatschek process, extrusion, mazza former, magnani, flow-on, casting, injection molding, hand lay-up, filter pressing, fourdrinier forming, multi-wire forming, gap blade forming, gap roll/blade forming, bel-roll forming, and others.

Step 135: Precure the Article

In this step, the fiber cement article is precured for at least about 12-24 hours. This typically takes place in an ambient environment.

Step 136: Cure Article

In this step, the fiber cement article is cured in an autoclave at elevated temperature and pressure for at least 8 hours. Alternatively, the article can be cured for 25 to 30 days at ambient conditions.

Step 137: Apply Finish and Dry Article

In this step, the appropriate finish is applied to the fiber cement article and dried or cured.

Step 138: Stack & Ship Material

In this step, the fiber cement articles are stacked and packaged for storage or shipment

FIG. 1C illustrates a method 104 of manufacturing a mold resistant building article of one preferred embodiment by incorporating a biocide admixture in the formulation of the article. The method 104 includes the following steps.

Step 140: Batch Raw Materials

In this step, raw materials are batched in a vessel in accordance with known formulations and operation procedures. A formulation for the preferred embodiments of this step comprises the formulation described above in Step 110 of FIG. 1A.

Step 141: Add Biocide Admixture

In this step, a biocide admixture is added to the batching vessel. The biocide admixture preferably comprises a biocide such as copper oxine. In one embodiment, the admixture comprises about 0%-3%, preferably about 0.0001%-1%, more preferably about 0.001%-0.5% of the dry weight of the formulation, excluding water. The admixture can be in the form of a powder or dispersion solution.

Step 142: Form Mixture

In this step, the raw materials and biocide are mixed together to create a fiber cement mixture.

Step 143: Form greensheet

In this step, the fiber cement mixture is made into a fiber cement article by known methods such as the Hatschek process, extrusion, mazza former, magnani, flow-on, casting, injection molding, hand lay-up, filter pressing, fourdrinier forming, multi-wire forming, gap blade forming, gap roll/blade forming, bel-roll forming, and others.

Step 144: Precure Article

In this step, the fiber cement article is procured for at least 12-24 hours.

Step 145: Cure/Dry Article

In this step, the fiber cement article is cured in an autoclave at elevated temperatures such as about 180° C. and pressures for at least 8 hours. Alternatively, the article can be cured for 25 to 30 days at ambient conditions.

Step 146: Apply Finish

In this step, a coating or finish is applied to the fiber cement article using conventional methods. The coating or finish can include paint, primer, sealant, or other surface finish.

Step 147: Stack Material

In this step, the fiber cement articles are stacked and packaged for storage of shipment.

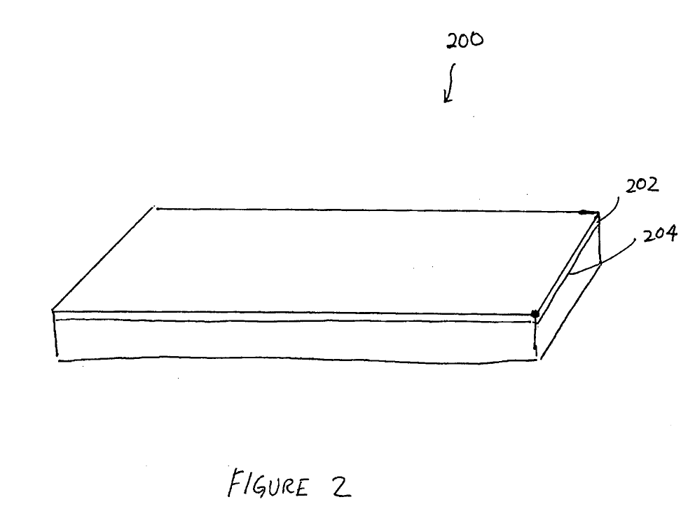

FIG. 2 illustrates a building article 200 comprising a surface treatment 202 that is substantially resistant to mold growth. As shown in FIG. 2, the surface treatment 202 is applied directly to a first surface 204 of the article 200. Preferably, the first surface 204 is positioned adjacent to a wet area when installed. In one embodiment, the surface treatment 202 is a thin film and can be applied using a variety of known techniques. The building article shown in FIG. 2 can be a tile backer board, deck, fence, trim, soffit, fascia, or the like. The building article can be made of a material including but not limited to cement, fiber cement, gypsum, gypsum fiber composite, wood, hardboard, medium density fiberboard, oriented strandboard, and wood/polymer composites. In one preferred embodiment, the surface treatment 202 utilizes copper oxine as the biocide.

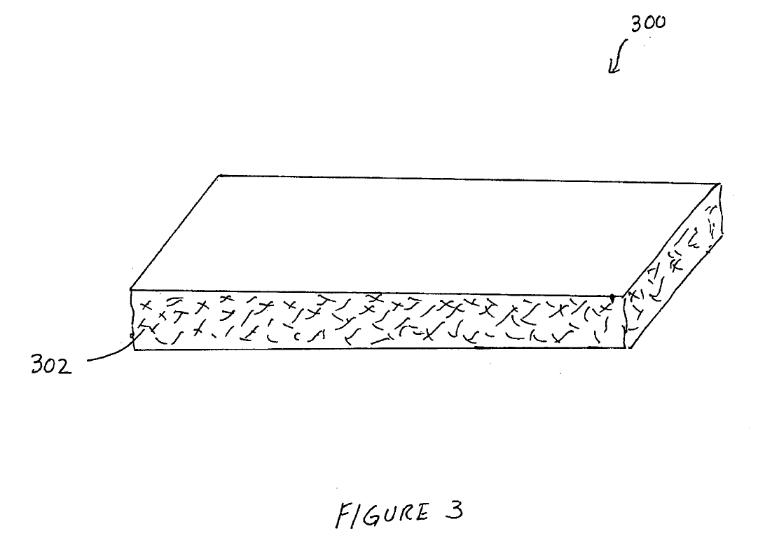

FIG. 3 illustrates a building article 300 incorporating one or more biocides 302 in the matrix of the material forming the article. In one embodiment, the building article 300 comprises a predominantly gypsum based core with paper sheets bonded to opposing surfaces of the core. Preferably, the gypsum core material is formed in accordance with the following ingredients and formulation: about 80 parts by weight of calcined gypsum of purity between about 75% and 100%; about 20 parts by weight of inert anhydrous calcium sulfate; about 1 part by weight of a set accelerator; about 1 part by weight of a fibrous material; about 1 part by weight of starch; about 0.04 part by weight of a foaming agent; and about 100 parts by weight of water. In one embodiment, the gypsum core material also comprises about 0.05 to 1.5 parts by weight of a biocide, such as copper oxine. Paper sheets suitable for bonding to the gypsum core material are well known in the art and may be selected based upon the desired weight and performance properties of the final gypsum wallboard product. In certain embodiments, the paper sheet covers are treated with a biocide, preferably copper oxine, such that the biocide comprises about 0.005%-5% of the dry weight of the treated paper sheet. The biocide may be applied to the paper sheet covers by spraying a solution of biocide directly onto the formed paper sheet or by treating the fibers incorporated in the sheet prior to forming the sheet. The gypsum core and paper sheet covers are assembled, cured, and processed in accordance with known techniques for making gypsum wallboard, including but not limited to that disclosed in U.S. Pat. No. 3,189,511, which is hereby incorporated by reference.

In another embodiment, the building article 300 comprises a gypsum/wood fiber composite incorporating a biocide comprising copper oxine. In certain implementations, the gypsum/wood fiber composite material can be made by mixing about 0.5% to 30%, preferably about 10% to 20% by weight, of copper oxine treated wood fibers with ground but uncalcined gypsum; combining the dry mix with sufficient liquid, preferably water, to form a dilute slurry having about 70% to 95% by weight water; processing the slurry in a pressure vessel at a temperature sufficient to convert the gypsum to calcium sulfate hemihydrate. In certain embodiments, it is desirable to continuously agitate the slurry with gentle stirring or mixing to break up any fiber clumps and keep the particles in suspension. After the hemihydrate has precipitated out of solution and recrystallized, the slurry can be dewatered to form a filter cake. Preferably, about 70% to 90% of the uncombined water is removed from the slurry. If the hemihydrate state of the composite material is desired, the filter cake is sustained at high temperature, for example about 180° F., until all remaining free water is driven off. The dried filter cake can then be broken up to form a powder or particulate material for easy handling, storing and reshaping.

Alternatively, the dewatered filter cake material can be immediately pressed, molded or otherwise shaped and allowed to cool to a temperature whereupon the calcium sulfate hemihydrate will hydrate to gypsum while still in situ in and around the wood fibers. After hydration is complete, the solidified mass is preferably dried promptly to remove any residual free water. While the resulting filter cake is still hot, it is wet pressed into a board of desired thickness and/or density. If the board is to be given a special surface texture or a laminated surface finish, it would preferably occur during or following this step of the process. After rehydration is complete, the board can be cut and trimmed, if desired, and then sent through a kiln for drying. Preferably, the drying temperature should be kept low enough to avoid recalcining any gypsum on the surface. Further details regarding making gypsum wood fiber composites are described in U.S. Pat. No. 5,320,677, which is hereby incorporated by reference.

In yet another embodiment, the building article 300 is made of a polymer composite material, such as a wood/polymer composite. In one embodiment, the wood/polymer composite material comprises about 25% to 75% thermoplastic resin binder, about 25% to 75% wood particles or fibers, and up to about 5% biocide. Preferably, the biocide is copper oxine. Suitable thermoplastic binders include but are not limited to polyvinyl chloride (PVC), high-density polyethylene (HDPE), low density polyethylene (LDPE) polypropylene (PP) and polystyrene (PS). In certain embodiments, commercial wood particles may be used with mesh sizes of 20 to 100, preferably 40 to 80-mesh range. Wood fibers may be used to improve the bending strength of the composite. Wood fibers having length to width aspect ratio of about 10:1 to 20:1 are preferred. The wood polymer composites may be formed by melt blending pellets of wood/polymer resin in the proportion described above with biocide admixture and extruding or injection molding the mixture to the desired shape. Alternatively, wood fibers treated with biocide may be treated with biocide as described herein dried and melt blended with thermoplastic resin to form pellets of a predetermined size and shape. These pellets may then be extruded or injection molded in a separate process to form final products of the desired shape.

The biocides described herein are also suitable for incorporating into other wood polymer composites using the formulations and methods described in U.S. Pat. No. 5,516,472, U.S. Pat. No. 5,088,910, U.S. Pat. No. 5,746,958 and U.S. Pat. No. 5,851,469, each incorporated herein as references.

In other embodiments, the building article 300 can also comprise a wood composite material such as hardboard, medium density fiberboard (MDF), particle board, oriented strand board (OSB), laminated veneer lumber (LVL) or plywood. In certain implementations, the wood composite comprises wood or cellulosic materials, one or more binders, and a biocide. The wood composite may also contain a hydrophobic material such as wax, petrolatum, stearate, silane or any other known hydrophobe. The wood or cellulosic materials may be wood fibers, flakes, veneers or particles. The binder may comprise a curable resin including but not limited to a phenol-formaldehyde resin, a resorcinol-formaldehyde resin, a urea-formaldehyde resin, a melamine-urea-formaldehyde resin, an isocyanate or polyurethane based resin, or a drying oil such as linseed oil or tung oil, or a blend of one or more of these. The biocide may be any of the biocides described herein and is preferably copper oxine.

In one embodiment, the wood or cellulosic materials are treated with a liquid solution of biocide and such that biocide comprises about 0.005%-5% of the dry weight of the treated wood materials. Preferably, the biocide is copper oxine, which has a high affinity for cellulosic materials and is not significantly affected by the heat and pressure associated with producing wood composites. More preferably, the biocide treated entails applying a solution or mixture comprising about 0.1%-2% copper oxine, more preferably about 0.2%-1%, more preferably about 0.5% copper oxine to the wood or cellulosic materials by spraying. Alternatively, the biocide may be provided as a staged or timed-release biocide admixture as described herein, and blended with the wood or cellulosic materials. Alternatively, the biocide may be incorporated into the binder and applied to the wood or cellulose materials. The treated wood or cellulose materials can formed into a mat, cut to size and consolidated by heat and temperature in a heated press by using conventional methods. In one embodiment, the mat is formed and consolidated by using steam injection. Copper oxine is particularly suited to steam injection methods of making wood composition because it resists hydrolysis or leaching during steam treatment.

In one embodiment, a hardboard material comprising wood fiber having about 5-15% moisture content, about 4-8% phenolic resin binder, about 1-4% wax, and about 0.2-1% copper oxine is made. The binder is added to the wood fibers, and the mixture is formed into a fibrous mat which is fully compressed between the platens of a press. After the mat is fully compressed, heat in the form of steam is applied in a first injection to purge air and in a second injection throughout the mat to cure the resin. The moisture content of the mat before pressing is approximately 7-12% and the moisture content of the pressed board product is about 4-8%. The wax provides water repellent properties to the sealed pressed product. Other known additives or treatments may be provided to the wood fibers as desired such as aluminum chloride for machinability. As noted above, the method will also work well with a mat made from other lignocellulosic materials such as, for example, wood chips or particles.

The foregoing description of the preferred embodiment of the present invention has shown, described and pointed out the fundamental novel features of the invention. It will be understood that various omissions, substitutions, and changes in the form of the detail of the apparatus as illustrated as well as the uses thereof, may be made by those skilled in the art, without departing from the spirit of the invention. Consequently, the scope of the invention should not be limited to the foregoing discussions, but should be defined by appended claims.

1. A building article comprising copper oxine as a biocide for inhibiting mold growth, wherein said building article is comprised of a material selected from the group consisting of cement, fiber cement, gypsum, gypsum fiber composite, wood, hardboard, medium density fiberboard, oriented strandboard, and wood/polymer composites.

2. The building article of claim 1, wherein the copper oxine is mixed into and interspersed throughout at least a portion of the material forming the article.

3. The building article of claim 1, wherein the copper oxine is adhered to a first surface of the article.

4. The building article of claim 3, wherein the copper oxine directly contacts the first surface of the article.

5. The building article of claim 4, wherein the copper oxine extends from the first surface into subsurface layers of the building article.

6. The building article of claim 3, further comprising a coating formed on the first surface of the article to cover the copper oxine thereon.

7. The building article of claim 6, wherein said coating is selected from the group consisting of primers, sealants, and paints.

8. The building article of claim 1, wherein the biocide comprises about 0.025% to 2% copper oxine by weight of the material forming the article.

9. The building article of claim 1, wherein the building article is selected from the group consisting of tile backer boards, decks, soffits, trims, decking, fencing, roofing, cladding, and sheathing.

10. The building article of claim 1, wherein the building article comprises a gypsum based core having two opposing surfaces and paper sheets bonded to said opposing surfaces.

11. The building article of claim 12, wherein copper oxine is adhered to at least one surface of the paper sheets.

12. The building article of claim 12, wherein copper oxine is applied to fibers reinforcing the paper sheets.

13. The building article of claim 1, wherein the building article comprises a board.

14. The building article of claim 1, wherein the building article comprises a plank.

15. The building article of claim 1, wherein the building article comprises a stake.

16. The building article of claim 1, wherein the building article is reinforced with cellulose fibers.

17. A method of forming a building article that is resistant to mold growth, comprising:
forming a building article having a first surface, said building article is comprised of a material selected from the group consisting of cement, fiber cement, gypsum, gypsum fiber composite, wood, hardboard, medium density fiberboard, oriented strandboard, and wood/polymer composites; and
applying copper oxine to said first surface, wherein said first surface is selected from the group consisting of exterior surface, unfinished surface, pre-finished surface, and finished surface.

18. The method of claim 17, wherein the copper oxine is applied directly to said first surface.

19. The method of claim 17, wherein the copper oxine is applied to said first surface via a solution comprising about 0.1%-2% copper oxine, about 1%-10% additives and about 50%-99% water.

20. The method of claim 19, wherein said additives are selected from the group consisting of sealants, primers, and paints.

21. The method of claim 17, wherein forming a building article comprises forming a fiber cement board.

22. The method of claim 17, wherein forming a building article comprises forming a gypsum board.

23. The method of claim 17, wherein forming a building article comprises forming a wood composite board.

24. The method of claim 17, wherein forming a building article comprises forming a plank.

25. The method of claim 17, wherein forming a building article comprises forming a stake.

26. A method of forming a building material that is resistant to mold growth, comprising:
combining copper oxine with ingredients for forming a composite material selected from the group consisting of cement, fiber cement, gypsum, gypsum fiber composite, wood, hardboard, medium density fiberboard, oriented strandboard, and wood/polymer composites;
forming a mixture comprising the copper oxine and said ingredients wherein the biocide is dispersed throughout at least a portion of the mixture; and
processing said mixture to form a building material which incorporates the copper oxine therein.

27. The method of claim 26, wherein said ingredients comprise a hydraulic binder, aggregates, and fibers.

28. The method of claim 27, wherein processing said mixture comprises processing the copper oxine and ingredients into a green shaped article, followed by autoclave curing of said green shaped article.

29. The method of claim 26, wherein said building material comprises a panel.

30. The method of claim 26, wherein said building material comprises a plank.

31. The method of claim 26, wherein said building material comprises a stake.

32. A method of forming a fiber reinforced building material that is resistant to mold growth, comprising:
combining copper oxine treated fibers with ingredients for forming a composite material selected from the group consisting of cement, fiber cement, gypsum, gypsum fiber composite, wood, hardboard, medium density fiberboard, oriented strandboard, and wood/polymer composites; and
forming a building material that is reinforced with said copper oxine treated fibers.

33. The method of claim 32, wherein said copper oxine treated fibers comprises copper oxine treated cellulose fibers.

34. A building article comprising fiber cement and a biocide, wherein said biocide directly contacts the fiber cement and substantially inhibits mold growth therein.

35. The building article of claim 34, wherein said biocide is interspersed throughout at least a portion of the fiber cement.

36. The building article of claim 34, wherein said biocide is applied to a first surface of said article and contacts the fiber cement on said first surface.

37. The building article of claim 36, wherein the biocide penetrates the first surface of the article and extends into subsurface layers of the article.

38. The building article of claim 37, wherein the biocide extends into the article from said first surface for a depth of at least 10 microns.

39. The building article of claim 34, wherein said biocide is selected from the group consisting of copper oxine, zinc stearate, calcium borate, zinc borate, barium borate, zinc omadine, zinc omadine/zinc oxide mix, sub 10 micron copper powder, and mixtures thereof.

40. The building article of claim 34, wherein said biocide is substantially stable in an alkali environment.

41. The building article of claim 34, wherein the article is selected from the group consisting of primed fiber cement articles, prefinished fiber cement articles, tile backer boards, decks, soffits, trims, decking, fencing, roofing cladding, and sheathing.

42. The building article of claim 34, wherein the building article is a fiber cement sheet.

43. The building article of claim 34, wherein the building article is a gypsum plank.

44. The building particle of claim 34, wherein the building article is a hardboard.

45. A building material formulation, comprising:
a formulation for forming a composite material selected from the group consisting of cement, fiber cement, gypsum, gypsum fiber composite, wood, hardboard, medium density fiberboard, oriented strandboard, and wood/polymer composites; and
an admixture comprising a biocide.

46. The building material formulation of claim 45, wherein the admixture comprises a biocide selected from the group consisting of copper oxine, zinc stearate, calcium borate, zinc borate, barium borate, zinc omadine, zinc omadine/zinc oxide mix, sub 10 micron copper powder, and mixtures thereof.

47. The building material formulation of claim 45, wherein the admixture comprises a timed-release biocide.

48. The building material formulation of claim 45, wherein the admixture comprises a biocide solution mixed with a predetermined amount of porous glass, ceramic, mineral, or polymeric material so as to permit timed release of the biocide.

49. The building material formulation of claim 45, wherein the admixture comprises about 0.025-2% by weight of the formulation.

50. A method of forming a building article that is resistant to mold growth, comprising:
forming a fiber cement article having a first surface, wherein said first surface is selected from the group consisting of exterior surface, pre-finished surface and finished surface; and
applying a biocide to the first surface, wherein said biocide directly contacts said fiber cement.

51. The method of claim 50, wherein applying said biocide comprises applying a copper oxine solution.

52. The method of claim 50, further comprising applying a sealant to the fiber cement article after applying the biocide to the first surface of the article.

53. The method of claim 50, wherein applying said biocide comprises spraying a solution containing said biocide directly to the first surface.

54. The method of claim 50, wherein applying said biocide comprises applying a biocide having a viscosity of between about 1 and 1,000 centipoises.

55. The method of claim 50, wherein the biocide is applied to the first surface by a method selected from the group consisting of spray coating, dip coating, curtain coating, roller or brush coating, flooding, and vacuum coating.
